(19) United States
(12) Patent Application Publication
(10) Pub. No.: US 2025/0085834 A1
(43) Pub. Date: Mar. 13, 2025

(54) METHOD FOR BUILDING A MENU PAGE ON A HOST WITH A DISPLAY

(71) Applicant: Endress+Hauser Conducta GmbH+Co. KG, Gerlingen (DE)

(72) Inventors: Tilman Benkert, Stuttgart (DE); Stefan Robl, Hünxe (DE); Emilio Schiavi, Oberwil (CH); Vincent de Groot, St. Louis (FR)

(21) Appl. No.: 18/830,784

(22) Filed: Sep. 11, 2024

(30) Foreign Application Priority Data
Sep. 11, 2023 (DE) 10 2023 124 394.2

(51) Int. Cl. G06F 3/0482; G06F 3/14

(52) U.S. Cl. CPC G06F 3/0482; G06F 3/14

(57) ABSTRACT

The present disclosure discloses a method for building a menu page on a host with a display, wherein a field device, such as a sensor, is connected to the host. The method includes steps of creating a list for the host, with the list comprising at least one sensor-referenced parameter, transmitting the list from the host to the field device (subscribe), and transmitting the value of the at least one sensor-referenced parameter from the field device to the host as soon as the list is on the field device and as soon as the value of the at least one sensor-referenced parameter changes (stream). The method also includes building and displaying the menu page on the display with the current value of the at least one sensor-referenced parameter.

### CROSS-REFERENCE TO RELATED APPLICATION

The present application is related to and claims the priority benefit of German Patent Application No. 10 2023 124 394.2, filed on Sep. 11, 2023, the entire contents of which are incorporated herein by reference.

### TECHNICAL FIELD

The present disclosure relates to a method for building a menu page on a host with a display, wherein a field device, such as, is connected to the host.

### BACKGROUND

Field devices serving to capture and/or modify process variables are frequently used in process automation technology. Sensors, such as fill level measuring devices, flow meters, pressure and temperature measuring devices, pH-redox potential meters, conductivity meters, etc., are used for recording the respective process variables, such as fill level, flow, pressure, temperature, pH level, and conductivity. All devices which are process-oriented and which supply or process process-relevant information are referred to as field devices. In addition to the aforementioned sensors, units that are directly connected to a fieldbus and used for communication with superordinate units, such as remote I/Os, gateways, linking devices, and wireless adapters, are also generally referred to as field devices. The company group Endress+Hauser produces and distributes a large variety of such field devices.

Before startup, and to modify the function of the field device, it must be parameterized. Operating tools are used for parameterization, such as reading and/or writing parameters. Such operating tools are usually implemented in a communication unit that is separate from the field device in question, and are connected to the field device via a fieldbus or via a service interface of the field device (via which, if necessary, communication also takes place using a manufacturer-specific protocol). Also, such field devices must be parameterized accordingly by the control system in order to integrate the field devices into a control system. In addition to parameterization, diagnosis of field devices is also possible.

For this purpose, field devices offer the possibility of carrying out parameterization or diagnosis using a computer program that was specially developed for the given field device. In order to reduce the effort required to write a separate program for each field device, the cross-manufacturer concept of FDT/DTM was introduced in automation technology, with the aim of requiring only one program for all field devices. FDT stands for “field device tool”, and standardizes the communication and configuration interface between all field devices and control systems. The FDT interface is specified for this purpose and standardizes the data exchange between the field devices, the control system and/or an asset management system. The basis of this concept is the so-called FDT frame application, also known to experts as the FDT host, which is a software program that loads the device type manager (DTM for short). The device type manager is essentially a driver that contains all the functions, structure, parameters and a graphical user interface (GUI) for a specific field device, or possibly a device family, and is supplied by the field device manufacturer. Via the FDT host, into which the device type manager has been loaded, the field device can be parameterized and/or optionally diagnostic steps can be carried out by a higher-level unit, such as an operating tool or the control system.

In addition to the technology described above, so-called device descriptions (DD) are used to carry out parameterization and/or diagnosis of field devices. These device descriptions of the field devices being integrated are based on so-called machine description languages, such as the electronic device description language (EDDL), which is standardized in IEC 61804-3. EDDL is a text-based description language used to describe the field device and its functions. The description is based on syntactic and semantic specifications or rules and is similar to simple programming languages. The description thus generated in one or more files is also called an electronic device description file (EDD file). This device description is installed on a host, e.g. a handheld device, laptop, etc., and enables access to all data and parameters of the corresponding field device.

In addition to the two concepts described above, the FDI (field device integration) specification was created, which brings together the two field device integration techniques FDT/DTM and DD/EDDL. This FDI standard provides support for multiple process control communication protocols (e.g. HART, Foundation fieldbus, and Profibus), enabling process control systems to manage field devices using a universal set of tools. This universal tool kit, known as the FDI device packet, includes everything a host system consisting of a server and a client, such as a process control system, needs to integrate a field device. Each FDI device packet must contain a device description (EDD), which includes a variety of parameter definitions, parameter structures for context-specific considerations, and automated device procedures, such as calibration for a specific field device. An FDI device packet can contain user interface plug-ins, i.e. software components to support modern device startup and diagnostic functions.

The parameterization of the field device can be done in advance, i.e. before startup and offline, or with a field device already connected to a fieldbus, i.e. “online”.

In process automation, the term “online parameterization” refers to a process in which the settings (parameters) of a field device are read and changed via a remote connection, typically a fieldbus, such as HART or PROFIBUS. The technologies mentioned above, in which a device driver is loaded into a host application, are suitable for this purpose. This device driver contains a description of the device menu, which can be used to display the device settings in menu pages. The user navigates through these menu pages and in each case gains access to the parameters referenced in the page. When a menu page is displayed, the current values of the referenced parameters are read from the field device. In some cases, parameters are also periodically re-read from the field device (e.g. measured values, system status parameters).

The state of the art is to read the parameters for a menu page as follows: A “request” for a parameter (or a fixed grouping of parameters with a limited size) is transmitted from the host to the field device. The field device transmits the values of the parameter(s) in the “response”. The application must wait to receive the response before it can send the next request.

In recent years, new transmission technologies, such as Bluetooth LE (Low Energy), have also become established in process automation. These have a higher data rate than HART, for example, but have a significant latency, approximately in the order of 100 ms.

Even established technologies, such as FDI mentioned above, could use Bluetooth LE, WiFi and similar technologies as a transmission medium. However, the “request/response procedure” described above has the disadvantage that it takes a long time to transfer all parameters of a menu page, since latency comes into play with each request. This results in loading times of the menu page contents of several seconds, so the user has to wait until he can continue with the operation. This is the case when existing drivers for field devices are used with newer transmission types, such as Bluetooth.

### SUMMARY

The present disclosure is based on the object of accelerating the menu structure, such as reducing the latency, and above all continuing to use existing drivers for field devices even with modern transmission types.

The object is achieved by a method for building a menu page on a host with a display, wherein a field device, such as a sensor, is connected to the host. The method comprises the following steps: creating a list for the host, the list comprising at least one sensor-referenced parameter; transmitting the list from the host to the field device; transmitting the value of the at least one sensor-referenced parameter from the field device to the host as soon as the list is on the field device and as soon as the value of the at least one sensor-referenced parameter changes; and building and displaying the menu page on the display with the current value of the at least one sensor-referenced parameter.

The claimed method presented expands the established technologies, such as EDD and FDI (see below), with extensions that minimize the disruptive influence of latency, and thus waiting times, during operation/parameterization. Depending on the design of the method, existing device drivers can be reused unchanged or slightly extended. Only small adjustments to the host application and the field device software make it possible to circumvent the latency problem with the claimed method.

The request/response procedure of common technologies for online parameterization of field devices in process automation (such as EDD, FDI) is extended almost transparently for latency-prone transmission media (such as Bluetooth LE, WiFi) by a subscription streaming method that transmits the values of the relevant parameters in a latency-optimized manner and converts the existing requests into local accesses to cached parameter values. Without major development effort, existing technologies (e.g. EDD, FDI) can be used with transmission media, such as Bluetooth LE or WiFi, in a way that minimizes waiting times for the operator.

One embodiment provides that the at least one sensor-referenced parameter is the settings of the field device, measured values of the field device, diagnostic information of the field device, event counters of the field device and/or system status displays of the field device.

One embodiment provides that the at least one sensor-referenced parameter is a dynamic parameter, i.e. a parameter that changes frequently and quickly.

One embodiment provides that the host is designed as an FDI host, EDD host, FDT host or FDT-based FDI host.

One embodiment provides for the host to be configured as a client/server application.

One embodiment provides that the method further comprises the step of storing the transmitted value of the at least one sensor-referenced parameter in a cache on the host, and building the menu page based on the values in the cache.

One embodiment provides that the cache contains all sensor-referenced parameters of all lists.

One embodiment provides for a backup to be created and/or restored.

One embodiment provides for one list to be created for each menu page.

One embodiment provides that the list is iterative and adaptive, and includes the most frequently changing sensor-referenced parameters.

One embodiment provides that a new list replaces the previous list.

One embodiment provides that the list is created by a parser, such as an interpreter, on the host.

One embodiment provides that the list is created in advance and stored separately, such as together with the device description.

### BRIEF DESCRIPTION OF THE DRAWINGS

This is explained in more detail with reference to the following figures.

FIG. 1 shows a measuring system with a host and field device.

FIG. 2 shows the prior art method for building a menu page.

FIG. 3 shows the claimed method for building a menu page.

In the figures, the same features are labeled with the same reference signs.

### DETAILED DESCRIPTION

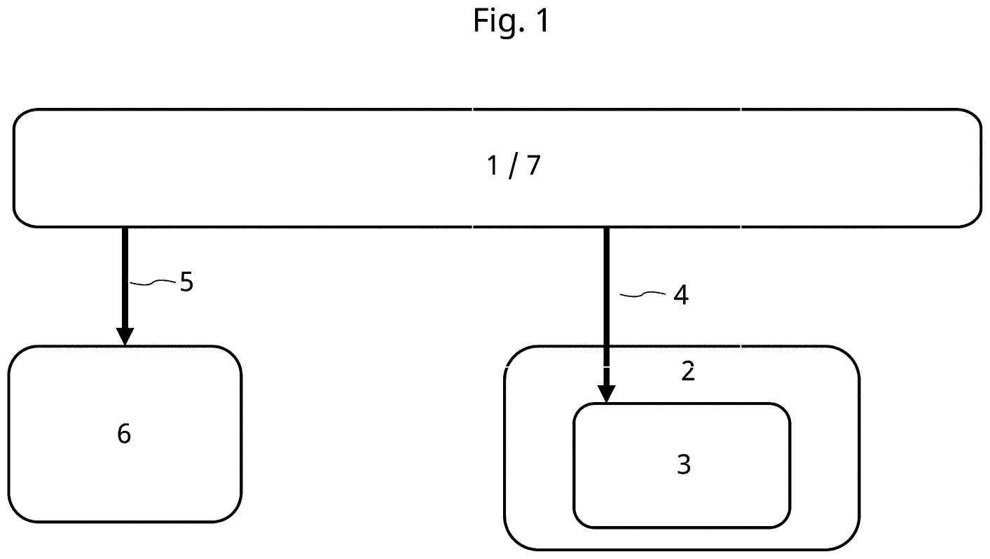

FIG. 1 shows a measuring system having a host 1 and a field device 2. The host includes a display/GUI (reference 7). The “host 1” in this document includes hardware (i.e. a computer with display 7) and software, for example an FDI host, EDD host, FDT host or an FDT-based FDI host. Examples of hardware are a control center PC, a laptop, a tablet or handheld or similar, for example the “FieldXpert” product from the Endress+Hauser Group. An example of software is the “FieldCare” product from the Endress+Hauser Group. The field device 2 is, for example, a sensor. The sensor 1 comprises multiple parameters 3. The host 1 has local access 5 to a device description 6, for example as part of the FDI packet from the driver. The field device 2 is connected to the host 1 via a remote access 4, for example Bluetooth or HART.

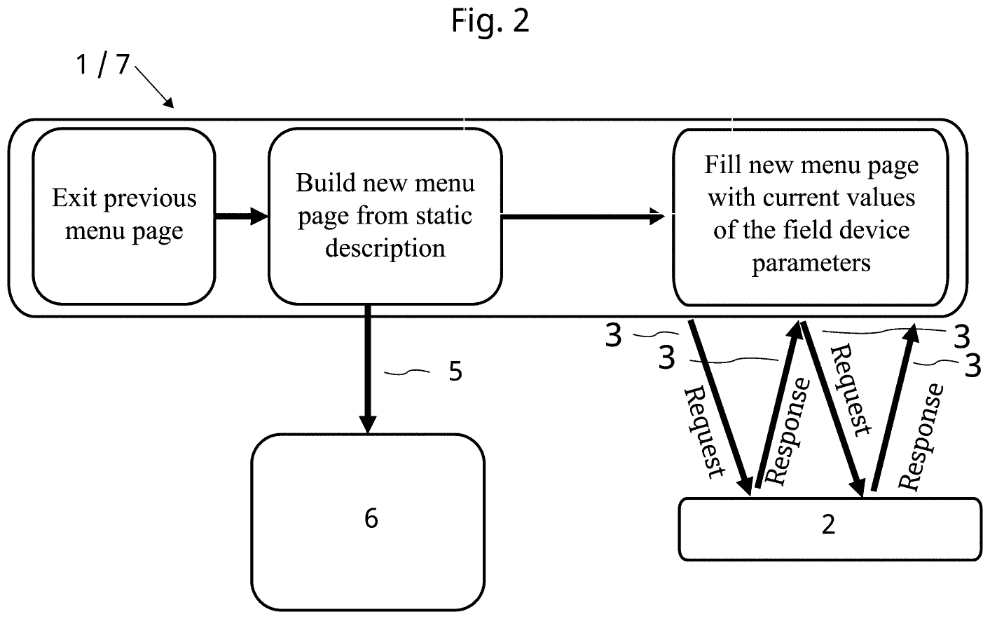

FIG. 2 shows the prior art method for building a menu page. If a page is left, the new page is built from the static description. The GUI 7 receives this information via local access 5 from the description of the device menu, for example from the driver, as part of the FDI packet. This new page must be filled with the current values of the parameter 3. To do this, the host 1 transmits a “request” with the individual parameter 3 to field device 2, which responds with the “response” with the value of the parameter. This is susceptible to latency. The new page can only be built once all parameters have been requested. This can sometimes take several seconds. FIG. 2 shows two requests with parameters, but there can be many more.

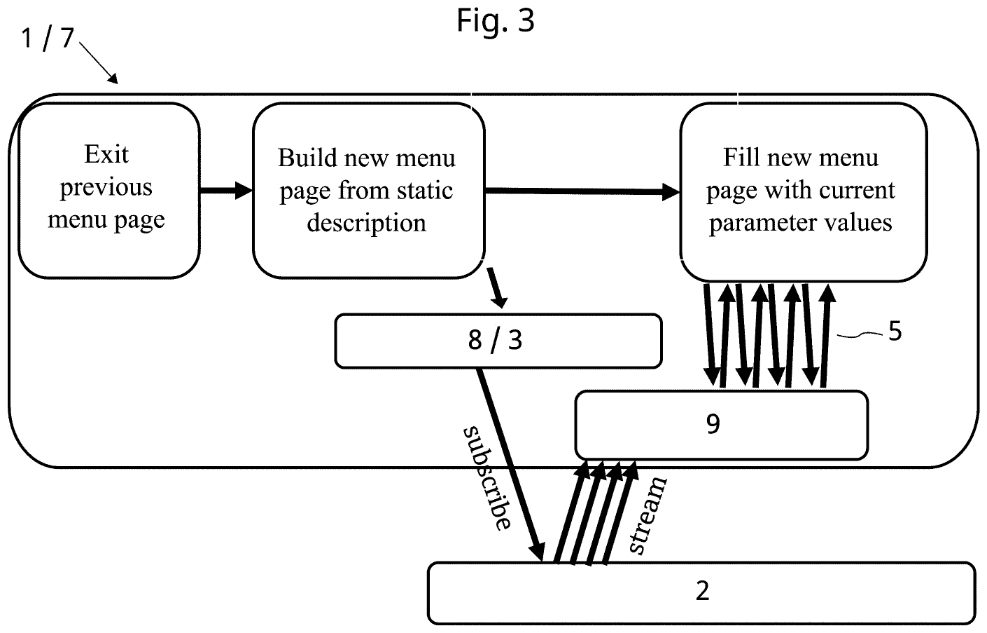

In contrast, FIG. 3 shows the claimed method for building a menu page.

The solution to the latency problem consists in extracting a list 8 of the relevant parameters 3 (the “sensor-referenced parameter” and/or the multiple sensor-referenced parameters) from the description of the menu page (e.g. EDDL code in the FDI packet) in the host 1. A list 8 is therefore created for the host (for example by the host itself; see below), the list 8 comprising at least one sensor-referenced parameter 3. The list can contain a variety of parameters 3. This list 8 is transmitted in its entirety to the field device 2. The field device supports a suitable transmission protocol. This process is a subscribe” or “subscription” process, because the host 1 informs the field device 2 which parameters 3 are relevant for the host application in the current situation.

The field device 2 then immediately transmits the current values of these parameters 3 without waiting for a response from the host application in each case. This is called “stream” or “streaming”. If values of a parameter 3 specified in the current list 8 change at a later point in time, the current value is transmitted to the host 1 without the latter having to take any action itself. In one embodiment, a periodic check can be carried out to see whether a value has changed.

Finally, the new menu page has been built and displayed on the display 7 with the current values of the sensor-referenced parameters 3.

Transferring a new list will replace the previous list.

The latency practically only comes into play between transmitting the (first) list and receiving the first parameter value.

In the host 1, the received parameter values are cached; this is the cache 9. The menu page is built based on the values in the cache.

The requests of the existing communication (when building menu pages and during periodic reading) of the host application are now redirected to this cache 9, that is, converted into local accesses. The first request may need to be delayed until the cache is full.

In one embodiment, the cache contains exactly the parameters of the active pages.

In one embodiment, the list 8 is iteratively and adaptively filled with the most frequently changing sensor-referenced parameters 3. This limits the cache 9 to frequently exchanged parameters. This list can be saved in the GUI 7 and reloaded when reconnecting to the device.

In one embodiment, the list 8 is created by a parser, such as an interpreter, on the host. The interpreter of the menu description (e.g. in EDDL) is thus extended, so that when parsing the information for the menu page to be displayed, it builds the list 8 of all referenced parameters 3 of this page. In one embodiment, the lists are pre-calculated and the list for the current page in each case is loaded from the driver.

In one embodiment, the interpreter of the menu description is extended, so that when parsing the device description, it (only) builds a list 8 of dynamically changing parameters 3, e.g. measured values, diagnostic information or event counters.

In one embodiment, list 8 contains only parameters 3 which change frequently.

In one embodiment, this list 8 is built per menu page, or across the entire menu. This primarily speeds up polling processes. Parameters 3 can be displayed for configuration only on a specific page. However, parameters 3 can be displayed as information on another page, or referenced in visibility conditions for other menu items. In addition, in one embodiment, there are pure display parameters, such as measured values that are to be displayed in different places, that is, each page has an individual list of referenced parameters, and these lists can overlap.

As such, there are at least the options to maintain an individual list for each menu page or to provide a global list for the entire menu structure (i.e. the totality of all menu pages). There can also be a kind of “favorites list” that contains the most frequently referenced parameters.

In one embodiment, the list is created in advance and stored separately, together with the device description. For example, during the development of the device description (e.g. FDI packet), an external (offline) parser can be used to pre-calculate the lists 8 of parameters 3 for each menu page and store them together with the conventional description. The existing parser is extended to report the change of page with its identification.

By means of the claimed method, larger quantities of parameters 3, for example, up to the entirety of the parameters 3, can be transmitted, for example in order to create or restore a backup.

1. A method for building a menu page on a host with a display, wherein a field device is connected to the host, the method comprising the steps of:
creating a list for the host, the list comprising at least one sensor-referenced parameter;
transmitting the list from the host to the field device (subscribe);
transmitting the value of the at least one sensor-referenced parameter from the field device to the host as soon as the list is on the field device and as soon as the value of the at least one sensor-referenced parameter changes (stream); and
building and displaying the menu page on the display with the current value of at least one sensor-referenced parameter.

2. The method according to claim 1,
wherein the at least one sensor-referenced parameter is the field device settings, field device measured values, field device diagnostic information, field device event counters, and/or field device system status indicators.

3. The method according to claim 1,
wherein the at least one sensor-referenced parameter is a dynamic parameter that changes frequently and quickly.

4. The method according to claim 1,
wherein the host is designed as an FDI host, EDD host, FDT host or FDT-based FDI host.

5. The method according to claim 1, further comprising the step of:
storing the transmitted value of at least one sensor-referenced parameter in a cache on the host, and building the menu page based on the values in the cache.

6. The method according to claim 5,
wherein the cache contains all sensor-referenced parameters of all lists.

7. The method according to claim 6,
wherein a backup is created and/or restored thereby.

8. The method according to claim 1,
wherein one list is created for each menu page.

9. The method of claim 1,
wherein the list is iterative and adaptive.

10. The method according to claim 1,
wherein a new list replaces the previous list.

11. The method according to claim 1,
wherein the list is created by a parser on the host.

12. The method according to claim 1,
wherein the list is created in advance and stored separately.
